(19) United States
(12) Patent Application Publication
(10) Pub. No.: US 2003/0179142 A1
(43) Pub. Date: Sep. 25, 2003

(54) Radio wave reflector, and structure with the radio wave reflector mounted thereon

(75) Inventors: Fuminori Nakamura, Nagaokakyo-shi (JP); Toru Tanizaki, Kyoto-shi (JP)

Correspondence Address: Keating & Bennett LLP, 10400 Eaton Place, Suite 312, Fairfax, VA, 22030, US

(73) Assignee: Murata Manufacturing Co., Ltd., Nagaokakyo-shi (JP)

(21) Appl. No.: 10/387,635

(22) Filed: Mar. 13, 2003

(30) Foreign Application Priority Data
Mar. 25, 2002 (JP) 2002-082270

(51) Int. Cl. H01Q 1/26

(52) U.S. Cl. 343/701

(57) ABSTRACT

A radio wave reflector has a function of reflecting radio waves in every direction in the plane including the incoming direction of the radio waves and can be fitted to various miscellaneous structures. The radio wave reflector includes a radio wave reflection material which is a conductor, and a base material including the radio wave reflection material in a non-contact state, and the conductor which is the radio wave reflection material is formed of a flaky or granular metal. The radio wave reflector includes the radio wave reflection material which is a dielectric, and the base material including the radio wave reflection material, and the dielectric which is the radio wave reflection material is formed of a flaky or granular ceramic.

### BACKGROUND OF THE INVENTION

1. Field of the Invention

The present invention relates to a radio wave reflector and a structure with the radio wave reflector mounted thereon, and more specifically, the present invention relates to a radio wave reflector for reflecting a radio wave incoming from the outside thereof, and a structure which is a marker or an installation or other member having the radio wave reflector mounted thereon.

2. Description of the Related Art

Visual guidance sheets to ensure the safe traveling of a car have been provided on a road surface or a side of a road on which the car travels, and these visual guidance sheets include one which emits light in an area having a dark viewing field such as during night time. For example, in Japanese Unexamined Patent Application Publication No. 10-102436, the visual guidance sheet which emits light when irradiated with light is disclosed, and the visual guidance sheet is formed by fixing an inorganic ceramic light emitting body containing a light emitting substance which emits light when irradiated with light to a surface of a sheet formed of a plastic or a cloth.

The conventional visual guidance sheet has a configuration in which only an inorganic ceramic light emitting body is included, and the light is emitted when irradiated with light. It is thus not definitely assured that a driver driving a car sees the visual guidance sheet, and in an actual state, it is not certain whether safe traveling is sufficiently ensured.

In recent years, a system has been proposed in which safe traveling is automatically ensured by disposing a radio wave radar on a front of the car, and detecting reflection of a millimeter wave or the radio wave of higher frequency based on a millimeter wave transmitted from the radio wave radar by markers or installations located along the periphery of the road. However, in such a system, the marker and the installation including a destination sign on the road surface or a guard rail installed on the road side must be a structure that is capable of reflecting the radio wave, i.e., a radio wave reflector.

In other words, in the system of utilizing the radio wave radar, the markers and installations in the periphery of the road, for example, structures including the destination sign, a noise barrier, a guard rail, and a curb must be reliably detected. However, if these structures themselves do not reflect the radio wave, the detection by the radio wave radar is impossible, and a separate radio wave reflector must be provided. In addition, the reflection of the radio wave incoming from a specified direction alone is insufficient, and even the radio wave incoming from a plurality of non-specified directions must be reflected in every direction in the imaginary plane including the incoming direction.

### SUMMARY OF THE INVENTION

In order to overcome the problems described above, preferred embodiments of the present invention provide a radio wave reflector which has a function of reflecting radio waves in every direction including the incoming direction of the radio wave, and can be fitted to various kinds of miscellaneous structures, and a structure to which the radio wave reflector is fitted.

A radio wave reflector according to a first preferred embodiment of the present invention preferably includes a radio wave reflection material which is a conductor, and a base material including the radio wave reflection material in a non-contact state.

A radio wave reflector according to a second preferred embodiment of the present invention is preferably a radio wave reflector according to the first preferred embodiment of the present invention, wherein the conductor is formed of a flaky or granular metal.

In the radio wave reflector of this configuration, the radio wave reflection material which is the conductor formed of the flaky or granular metal is included in the base material in a non-contact state, and the radio wave incoming on the radio wave reflector is reflected in every direction in the imaginary plane including the incoming direction by the conductor (metal) which is the radio wave reflection material. The essential condition is that the radio wave reflection materials are arranged in a non-contact state with each other.

A radio wave reflector according to a third preferred embodiment of the present invention preferably includes a radio wave reflection material which is a dielectric material, and a base material including the radio wave reflection material.

The radio wave reflector according to a fourth preferred embodiment of the present invention is preferably the radio reflector according to the third preferred embodiment of the present invention, wherein the dielectric is a flaky or granular ceramic.

In such a radio wave reflector, the radio wave reflection material which is a conductor formed of the flaky or granular ceramic is included in the base material, and the radio wave incoming on the radio wave reflector is reflected in every direction in the imaginary plane including the incoming direction by the conductor (ceramic) which is the radio wave reflection material.

A radio wave reflector according to a fifth preferred embodiment of the present invention is the radio wave reflector according to the fourth preferred embodiment of the present invention, wherein the outline of the ceramic is substantially spherical. If the outline of the ceramic is substantially spherical, the radio wave incoming on the radio wave reflector can be reflected at a specified level.

A radio wave reflector according to a sixth preferred embodiment is a radio wave reflector according to the fourth or fifth preferred embodiment of the present invention, wherein the specific dielectric constant of the ceramic is not less than 5. If the specific dielectric constant of the ceramic is not less than 5, high reflection efficiency can be obtained.

A radio wave reflector according to a seventh preferred embodiment of the present invention is the radio wave reflector according to the second preferred embodiment of the present invention, wherein the metal is an industrial waste of electronic components. In this radio wave reflector, the industrial waste can be effectively recycled.

A radio wave reflector according to an eighth preferred embodiment of the present invention is the radio wave reflector according to the fourth or fifth preferred embodiment of the present invention, wherein the ceramic is an industrial waste of electronic components. In this radio wave reflector, the industrial waste can be effectively recycled.

A radio wave reflector according to a ninth preferred embodiment of the present invention is the radio wave reflector according to the first or third preferred embodiment of the present invention, wherein the entire outline of the base material including the radio wave reflection material is sheet-like. In this configuration, the radio wave reflector including the radio wave reflection material and the base material is a flat sheet, and similar to a conventional visual guidance sheet, the radio wave reflector can be easily fitted to a structure including a marker and an installation in the periphery of the road.

A radio wave reflector according to a tenth preferred embodiment of the present invention is the radio wave reflector according to the ninth preferred embodiment of the present invention, wherein a projection portion defined by the base material including the radio wave reflection material is provided on a radio wave incoming side surface of the sheet. In other words, in the radio wave reflector according to the eigth preferred embodiment of the present invention, it is difficult to reflect the radio wave incoming from the tangential direction close to the radio wave incoming side surface, but if the projection portion defined by the base material including the radio wave reflection material is provided on a radio wave incoming side surface of the sheet-like radio wave reflector, the radio wave incoming from the tangential direction close to the radio wave incoming side surface can be reflected.

A radio wave reflector according to an eleventh preferred embodiment of the present invention is the radio wave reflector according to the first or third preferred embodiment of the present invention, wherein the base material including the radio wave reflection material is either a paint, an adhesive, or a concrete.

A structure according to a twelfth preferred embodiment of the present invention is a structure to which a radio wave reflector is fitted, wherein the radio wave reflector according to the first or third preferred embodiment of the present invention is fitted to at least a portion thereof. If such a structure is provided in the periphery of or along the road, not only the radio wave incoming from a specified direction but also the radio wave incoming from a plurality of non-specified directions can be reliably reflected.

Other features, elements, characteristics and advantages of the present invention will become more apparent from the following detailed description of preferred embodiments with reference to the attached drawings.

### BRIEF DESCRIPTION OF THE DRAWINGS

FIG. 1 is an illustration of a first configuration of a radio wave reflector according to a preferred embodiment of the present invention;

FIG. 2 is an illustration of a second configuration of a radio wave reflector according to a preferred embodiment of the present invention;

FIG. 3 is a side view of a specific example of the first and second configurations of the radio wave reflector;

FIG. 4 is a side view of a modification thereof; and

FIG. 5 is an illustration of an example of a structure with the radio wave reflector mounted thereon.

### DETAILED DESCRIPTION OF PREFERRED EMBODIMENTS

Preferred embodiments of the present invention will be described below with reference to the drawings.

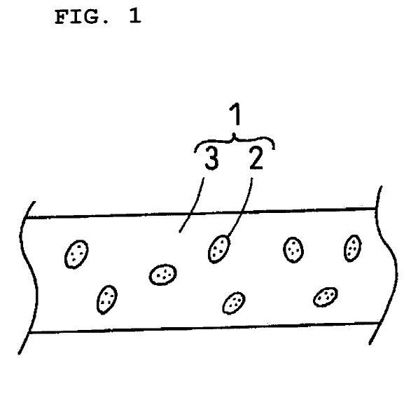

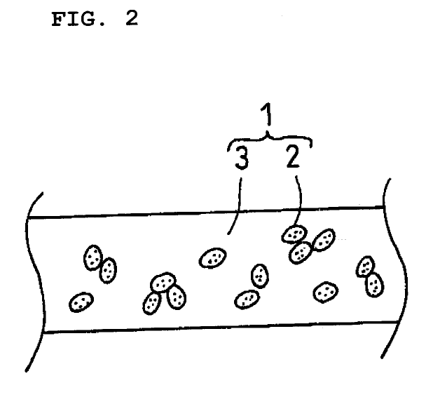

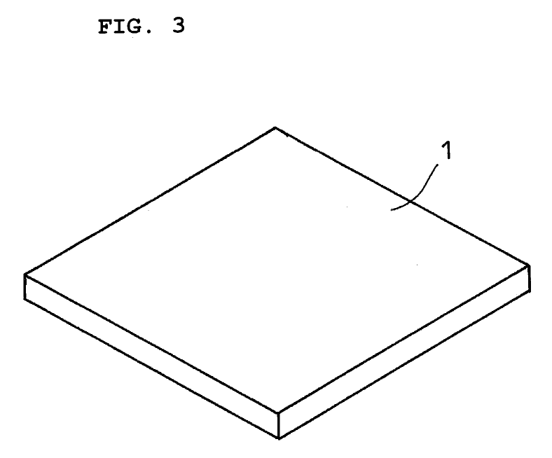

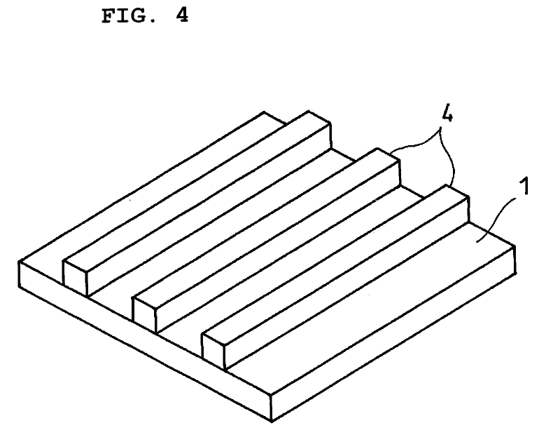

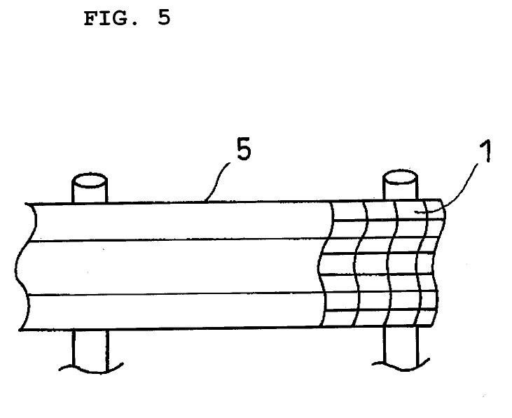

FIG. 1 is an illustration of a first configuration of a radio wave reflector according to the present preferred embodiment, FIG. 2 is an illustration of a second configuration thereof, and FIG. 3 is a side view showing a specific example thereof. FIG. 4 is a side view showing a modification thereof, and FIG. 5 is an illustration of an example of a structure with the radio wave reflector mounted thereon. Reference numeral 1 in FIGS. 1 to 5 denotes the radio wave reflector.

The radio wave reflector 1 according to the present preferred embodiment is preferably made of a radio wave reflection material 2 which is a conductor and a base material 3 such as a paint, an adhesive and a concrete including the radio wave reflection material 2 in a non-contact state in the first configuration as shown in FIG. 1, and the radio wave reflection material 2 is preferably formed of a flaky or granular metal. In other words, the radio wave reflector 1 has a configuration in which metal flakes or metal grains are contained in the base material 3 such as the paint in a diffused manner so as not to be brought into contact with each other. The radio wave reflector 1 may be formed of a plurality of lumps.

In the radio wave reflector 1 of this configuration, each radio wave reflection material 2 formed of the metal flakes or grains included in the base material 3, such as the paint, reflects the radio wave incoming on the radio wave reflector 1, for example, the millimeter wave or the radio wave of the higher frequency than that of the millimeter wave transmitted from a radio wave radar mounted on a car in every direction in the imaginary plane including the incoming direction. Therefore, the incoming radio wave is reflected outwardly from this radio wave reflector 1 irrespective of the the incoming direction of the radio wave with respect to the radio wave reflector 1, and the thus-reflected radio wave is received by the radio wave radar mounted on the car.

The radio wave reflector 1 is, needless to say, not limited to that formed of the radio wave reflection material 2 which is preferably a conductor such as a metal. In other words, as shown in FIG. 2, the radio wave reflector 1 may be formed of the radio wave reflection material 2 which is a dielectric, for example, a ceramic, and a base material 3 such as a paint including this radio wave reflection material 2, and the ceramic forming the radio wave reflector 2 may be flaky or granular.

In a case of the radio wave reflector 2 which is formed of the ceramic, the radio wave reflection materials 2 need not be disposed in a non-contact manner with each other because there are no troubles in reflecting the radio wave even when these materials are brought into contact with each other.

Also, in a case of the radio wave reflector 1, i.e., the radio wave reflector 1 including the radio wave reflection material 2 formed of the ceramic in the base material 3, each of the radio wave reflection materials 2 included in the base material 3 reflects the incoming radio wave on the radio wave reflector 1 in every direction in the imaginary plane including the incoming direction in a manner similar to a case of the radio wave reflector including the radio wave reflection material 2 which is a conductor such as a metal. Irrespective of the incoming direction of the radio wave to the radio wave reflector 1, the radio wave reflected outwardly from this radio wave reflector 1 is similarly received by the radio wave radar mounted on the car.

The ceramic forming the radio wave reflection material 2 preferably has a substantially spherical outline, and in a case of the radio wave reflection material 2 formed of the ceramic having the substantially spherical outline, an advantage is ensured in that the intensity of the radio wave incoming on the radio wave reflector 1 formed of the base material 3 including these radio wave reflection materials 2 reaches a specified level. In addition, the ceramic forming the radio wave reflection materials 2 need not have the substantially spherical outline, and needless to say, the ceramic may have a columnar, polygonal-prismatic, or polygonal-conical outline, or other suitable outline.

The ceramic forming the radio wave reflection material 2 preferably has the specific dielectric constant of not less than 5. If the radio wave reflector 1 is formed of the ceramic of the dielectric constant of not less than 5, high reflection efficiency can be obtained. In addition, the ceramic or the metal is preferably considered to be an industrial waste of electronic components. This is because electronic components such as capacitors are generally manufactured in a factory for manufacturing the radio wave reflector 1 according to the present preferred embodiment, and if the industrial waste of the electronic components is utilized, the amount of reclamation is reduced, and the industrial waste can be effectively recycled.

In addition, in each of the radio wave reflectors 1 according to the present preferred embodiment, i.e., in each of the radio wave reflectors 1 in which the radio wave reflection materials 2 formed of the metal or the ceramic are included in the base material 3, as specifically shown in FIG. 3, the entire outline of the base material 3 including the radio wave reflection materials 2 preferably has a sheet-like shape. This means that the base material 3 constituting the radio wave reflector 1 is not limited to the paint, the adhesive or concrete, but the radio wave reflector 1 can be manufactured as a sheet if the base material 3 is formed of a material such as a synthetic resin which remains flexible even after it is cured.

If the radio wave reflector 1 is formed in a sheet, the radio wave reflector 1 can be easily fitted to the structure, i.e., the structure such as a marker and an installation in the periphery of roads, for example, a destination marker and a noise barrier by using the adhesive or other suitable material.

Conversely, the radio wave reflector 1 is formed in a sheet, and as shown in FIG. 4, a projection portion 4 formed of the base material 3 including the radio wave reflection material 2 formed of a metal or ceramic may be provided on a radio wave incoming side surface of the radio wave reflector 1 while it is placed in the direction that is substantially perpendicular to the incoming direction of the radio wave. In other words, if the radio wave reflector 1 is only formed in a sheet, difficulty in reflecting the incoming radio wave from the tangential direction close to the radio wave outgoing side surface cannot be avoided. However, if at least one of the plurality of projection portions 4 is provided on the radio wave incoming side surface of the sheet-like radio wave reflector 1, the radio wave incoming from the tangential direction close to this radio wave incoming side surface can also be reliably reflected.

In addition, the radio wave reflector 1 according to the present preferred embodiment may be fitted to various kinds of structures provided on the road surface or on the road side. FIG. 5 shows the sheet-like radio wave reflector 1 fitted to a guard rail 5 as a structure, and the radio wave incoming from a plurality of non-specified direction is reflected in every direction in the imaginary plane including the incoming direction by the radio wave reflector 1 fitted to the guard rail 5. Accordingly, in this condition, the radio wave is reflected toward the radio wave radar mounted on the car from the guard rail 5, and the structure can be detected based on the reflected radio wave in the car traveling on the road.

In this preferred embodiment, the sheet-like radio wave reflector 1 is fitted to the guard rail 5, but, needless to say, an object to which the radio wave reflector 1 is fitted is not limited to only the guard rail 5. In other words, the radio wave reflector 1 can naturally be fitted to markers and installations including a noise barrier, a sound-proof wall, a pier of an overpass or a pedestrian bridge, an interior plate in a tunnel, a marker material, a road surface marker, a delineator, a curved mirror, a pole cone, a car stop, a guard fence, a guard rail, a shelter, an illumination lamp, a fence, a snow pole, and a curb, i.e., any of various kinds of structures in the periphery of the road.

The radio wave reflector of various preferred embodiments of the present invention has a function of reflecting radio waves in every direction in the plane including the incoming direction of the radio waves, and an advantage of easily being fitted to various kinds of miscellaneous structures is achieved. If the radio wave reflector is sheet-like, an advantage is obtained in that the radio wave reflector can be fitted very easily to the structures including the markers and installations in the periphery of the road.

In addition, an advantage is ensured in that not only the radio wave incoming from a specified direction but also the radio wave incoming from a plurality of non-specified directions can be reliably reflected by the structure if the radio wave reflector of the present invention is fitted thereto.

It should be understood that the foregoing description is only illustrative of the present invention. Various alternatives and modifications can be devised by those skilled in the art without departing from the present invention. Accordingly, the present invention is intended to embrace all such alternatives, modifications and variances which fall within the scope of the appended claims.

What is claimed is:

1. A radio wave reflector comprising:
a radio wave reflection material which is a conductor; and
a base material including said radio wave reflection material arranged in a non-contact state.

2. A radio wave reflector according to claim 1, wherein said conductor is made of one of a flaky metal and a granular metal.

3. A radio wave reflector according to claim 2, wherein said metal is an industrial waste of electronic components.

4. A radio wave reflector according to claim 1, wherein an entire outline of the base material including said radio wave reflection material is a sheet configuration.

5. A radio wave reflector according to claim 4, wherein a projection portion defined by said base material including said radio wave reflection material is provided on a radio wave incoming side surface of said sheet.

6. A radio wave reflector according to claim 1, wherein the base material including said radio wave reflection material is one of a paint, an adhesive, and a concrete.

7. A radio wave reflector comprising:
a radio wave reflection material which is a dielectric; and
a base material including said radio wave reflection material.

8. A radio wave reflector according to claim 7, wherein said dielectric is made of one of a flaky ceramic and a granular ceramic.

9. A radio wave reflector according to claim 8, wherein an outline of said ceramic is substantially spherical.

10. A radio wave reflector according to claim 8, wherein the specific dielectric constant of said ceramic is not less than 5.

11. A radio wave reflector according to claim 8, wherein said ceramic is an industrial waste of electronic components.

12. A radio wave reflector according to claim 7, wherein an entire outline of the base material including said radio wave reflection material is a sheet configuration.

13. A radio wave reflector according to claim 12, wherein a projection portion defined by said base material including said radio wave reflection material is provided on a radio wave incoming side surface of said sheet.

14. A radio wave reflector according to claim 7, wherein the base material including said radio wave reflection material is one of a paint, an adhesive, and a concrete.

15. A radio wave reflector according to claim 7, wherein said radio wave reflection material is arranged in said base material in a non-contact state.

16. A structure comprising:
a body; and
a radio wave reflector including a radio wave reflection material which is a conductor and a base material including said radio wave reflection material arranged in a non-contact state, said radio wave reflector being fitted to a portion of the body.

17. A structure according to claim 16, wherein said conductor is made of one of a flaky metal and a granular metal.

18. A structure comprising:
a body; and
a radio wave reflector including a radio wave reflection material which is a dielectric and a base material including said radio wave reflection material, said radio wave reflector being fitted to a portion of the body.

19. A structure according to claim 18, wherein said radio wave reflector is arrangd in the reflection material in a non-contact state.
